(19) United States
(12) Patent Application Publication
(10) Pub. No.: US 2017/0193565 A1
(43) Pub. Date: Jul. 6, 2017

(54) METHOD OF AND SYSTEM FOR CREATING AND MANAGING A COMBINED ADVERTISEMENT USING A MOBILE DEVICE

(71) Applicant: Gert Frederick MEYER, Bryanston (ZA)

(72) Inventors: Gert Frederick MEYER, Bryanston (ZA); Gavin MANNING, Bryanston (ZA); Guy VAN DEN BERG, Centurion (ZA)

(21) Appl. No.: 15/127,231

(22) PCT Filed: Mar. 19, 2015
(86) PCT No.: PCT/IB2015/052010

§ 371 Date: Sep. 19, 2016

(30) Foreign Application Priority Data
Mar. 20, 2014 (ZA) 2014/02081

(51) Int. Cl. G06Q 30/02; H04L 29/06; G06F 17/30

(52) U.S. Cl. CPC G06Q 30/0276; G06F 17/30887; H04L 63/10; H04L 63/083; H04L 63/0861; H04W 4/14

(57) ABSTRACT

A method and system of compiling one or more advertisements is provided. The method includes receiving via a communications network a request from an advertiser to place an advertisement. The advertiser selects one or more product and/or service category in respect of which he or she wishes to advertise and then compiles information regarding one or more product and/or service to be advertised. The information is collated to define a primary advertisement. A secondary advertisement is then extracted from a database and appended to the primary advertisement, so as to define a combined advertisement which is transmitted to a device of a user, typically a mobile communications device.

### FIELD OF THE INVENTION

This invention relates to a method of and system for creating and managing a combined advertisement, typically on a mobile device. In particular, this invention relates to a method of and system for compiling and presenting a combined advertisement, in either an advertisement placement process in respect of a product or service, or an advertisement searching process in respect of a product or service, all using conventional mobile technologies, such as USSD (Unstructured Supplementary Service Data), SMS (Short Message Service) and MMS (Multimedia Message Service).

The combined advertisement comprises information regarding the product or service being placed/searched (i.e. a primary advertisement) as well as information regarding another product or service (i.e. a secondary advertisement), with the secondary advertisement ideally being related or connected to the subject matter of the primary advertisement.

### SUMMARY OF THE INVENTION

According to a first aspect of the invention there is provided a method of compiling an advertisement, the method comprising:
receiving via one or more communications network one or more request from one or more advertiser to place one or more advertisement;
allowing one or more advertiser to select one or more product and/or service category in respect of which he or she wishes to advertise;
prompting one or more advertiser via one or more communications network to compile information regarding one or more product and/or service to be advertised;
receiving via one or more communications network information regarding one or more product and/or service to be advertised;
collating the information to define a primary advertisement, comprising one or more of the following: the date, the advertiser's location, the advertiser's contact details and the product and/or service being advertised;
extracting from one or more database a secondary advertisement;
appending the secondary advertisement to the primary advertisement, so as to define a combined advertisement; and
transmitting one or more combined advertisement to one or more device.

In an embodiment, the step of allowing the advertiser to select a product or service category in respect of which he or she wishes to advertise comprises presenting the advertiser with a multi-level set of categories for selection by the advertiser.

In an embodiment, the step of allowing the one or more advertiser to select one or more product and/or service category in respect of which he or she wishes to advertise comprises presenting the one or more advertiser with a multi-level set of categories for selection by the one or more advertiser.

In an embodiment, the step of prompting the one or more advertiser to compile information regarding the one or more product and/or service to be advertised comprises the steps of prompting the one or more advertiser to provide the one or more body and/or title of the one or more advertisement.

In an embodiment, the secondary advertisement is related or connected to the product and/or service category and/or the product and/or service being advertised.

In an embodiment, the step of appending the secondary advertisement to the primary advertisement includes the step of appending the secondary advertisement to the footer (i.e. the end) of the primary advertisement.

In an embodiment, after appending the secondary advertisement to the primary advertisement, the method comprises sending the combined advertisement to the advertiser for approval, and upon receiving approval, the method comprises storing the combined advertisement in the database for subsequent retrieval.

In an embodiment, one or more primary advertisement are sent to one or more advertiser for approval, and upon receiving approval, the method comprises storing the one or more advertisement in one or more database for subsequent retrieval.

In an embodiment, after appending the secondary advertisement to the one or more primary advertisement, the method comprises sending the one or more combined advertisement to the one or more advertiser for approval, and upon receiving approval, the method comprises storing the one or more combined advertisement in the one or more database for subsequent retrieval.

In an embodiment, the one or more advertiser are allowed to request further information regarding the secondary advertisement, and sending one or more message with further details and/or contact details that the one or more advertiser may use and/or one or more URL link to one or more web site with further details.

In an embodiment, the method comprises the step of determining whether the advertiser is registered with a host running the method. If the advertiser is not registered, the method comprises registering the advertiser, which in turn comprises any one or more of the following steps:
presenting one or more introductory message and/or related terms and conditions, and prompting the one or more advertiser to accept the terms and conditions;
determining the advertiser's location;
prompting the one or more advertiser to set one or more PIN, for subsequent use to ensure that one or more operator of one or more device is authorized to place advertisements, and
capturing the one or more advertiser's payment information which can then be used automatically in future to place adverts.

In an embodiment, the one or more PIN is a biometric of the one or more advertiser.

In an embodiment, the method includes automatically suggesting one or more improvement to the one or more advert

In an embodiment, if the one or more primary advertisement is shorter than an allowed length, automatically increasing the size of the secondary advertisement.

In an embodiment, the method includes allocating one or more reference code to the one or more advert by which the one or more advertiser can quickly locate their one or more advert in the system.

In an embodiment, the mobile technology comprises any one or a combination of USSD (Unstructured Supplementary Service Data), SMS (Short Message Service) and MMS (Multimedia Message Service).

According to a second aspect of the invention there is provided a method of searching for an advertised product or service, the method comprising:
receiving via one or more communications network one or more request from one or more device associated with one or more user to search for one or more advertisement;
allowing one or more user to select at least one or more product and/or service category in respect of which he or she wishes to search;
prompting one or more user via one or more communications network to submit information regarding the one or more product and/or service to be searched;
receiving information via the one or more communications network regarding the one or more product and/or service to be searched;
searching one or more databases for matching products and/or services;
collating the information to define one or more primary advertisement, comprising of one or more matching product and/or service;
extracting from one or more databases a secondary advertisement;
appending the secondary advertisement to one or more primary advertisement, so as to define one or more combined advertisement; and
transmitting one or more primary and secondary advertisement to one or more device.

In an embodiment, the step of appending the secondary advertisement to the one or more primary advertisements includes the step of appending the secondary advertisement to the header, looter or middle or any suitable place of the one or more primary advertisements.

In an embodiment, the method comprises sending the one or more combined advertisements to the one or more users, and prompting the one or more users to select one or more matching product and/or service in respect of which he or she is particularly interested in.

In an embodiment, the method further comprises extracting from the database further information regarding the selected product and/or service, including one or more of the following: the date of advertisement, the advertiser's location, the advertiser's contact details and/or the product and/or service being advertised.

In an embodiment, the method comprises:
collating the information extracted from the one or more databases to define one or more primary advertisement;
appending the secondary advertisement to the primary advertisement, so as to define one or more combined advertisement; and
sending the one or more combined advertisement to the subscriber.

In an embodiment, the secondary advertisement is related and/or connected to the product or service category and/or the product and/or service being searched.

In an embodiment, the step of prompting the one or more user to submit information regarding the product and/or service to be searched includes the step of allowing the one or more user to search for all advertised products and/or services.

In an embodiment, in the event that the one or more users wish to search for all advertised products and/or services, the secondary advertisement is randomly chosen from the one or more database.

In an embodiment, the method further comprises allowing the one or more user to request further information regarding the secondary advertisement, which in turn comprises sending one or more message with further details and/or contact details that the one or more user may use and/or one or more URL link to one or more website with further details.

In an embodiment, the method further comprises transmitting one or more primary and secondary advertisement to one or more e-mail address of one or more user.

In an embodiment, the method further comprises including transmitting the one or more primary and secondary advertisement to one or more device in one or more user language.

In an embodiment, one or more primary and secondary advertisement are transmitted to one or more application executing on one or more device.

In an embodiment, the method further comprises including transmitting the one or more primary and secondary advertisement to one or more device via one or more email and/or social network application.

In an embodiment, the method further comprises:
appending a different secondary advertisement to the primary advertisement, so as to define a different combined advertisement; and
transmitting the different combined advertisement to the device.

In an embodiment, the different secondary advertisement is appended to the primary advertisement when the one or more user changes location.

In an embodiment, if no matching product and/or service is found, storing the one or more request and if one or more product and/or service does become available at a future point in time, transmitting one or more appropriate advert together with a secondary advert to one or more user via any suitable communication means.

In an embodiment, the method further comprises the request received from one or more device associated with one or more user is received via USSD.

In an embodiment, the method further comprises displaying the one or more combined advert on the one or more user device.

According to a third aspect of the invention there is provided a system for compiling an advertisement, the system comprising:
one or more database to store a plurality of secondary advertisements; and
one or more processor to access one or more database, and which is arranged to:
   receive via one or more communications network one or more request from one or more device associated with one or more advertiser to place one or more advertisement;
   allow the one or more advertiser to select via the one or more communications network one or more product and/or service category in respect of which he or she wishes to advertise;
   prompt the one or more advertiser via the one or more communications network to compile information regarding the one or more product and/or service to be advertised;
   receive via the one or more communications network information regarding the one or more product and/or service to be advertised;
   collate the information to define a primary advertisement, comprising of one or more of the following: the date, the advertiser's location, an advertiser's contact details and/or the product and/or service being advertised;
   extract from the one or more database a secondary advertisement; and
   append the secondary advertisement to the one or more primary advertisement, so as to define one or more combined advertisement.

According to a fourth aspect of the invention there is provided a system for searching for an advertised product or service, the system comprising:
one or more database to store a plurality of advertised products and/or services and a plurality of secondary advertisements; and
one or more processor to access the one or more database, and which is arranged to:
   receive via one or more communications network one or more request to search one or more advertisement from one or more device associated with one or more user;
   determine the one or more user's location, by presenting the one or more user with a multi-level set of locations for selection by the one or more user;
   allow the one or more user to select one or more product and/or service category in respect of which he or she wishes to search;
   prompt the one or more user via the one or more communications network to submit information regarding the one or more product and/or service to be searched;
   receive information via the one or more communications network regarding the one or more product and/or service to be searched;
   search the one or more database for matching products and/or services;
   collate the information to define one or more primary advertisement, comprising of one matching product and/or service;
   extract from the one or more database a secondary advertisement; and
   append the secondary advertisement to the one or more primary advertisement, so as to define one or more combined advertisement.

### BRIEF DESCRIPTION OF THE DRAWINGS

These and other features of this invention will become apparent from the following description of one example described with reference to the accompanying drawings in which:

FIG. 1 shows a high level schematic view of a system for compiling an advertisement, according to a first embodiment of the invention;

FIG. 2 shows a flow chart representing a method of compiling an advertisement, which may be implemented using the system in FIG. 1, according to a second embodiment of the present invention;

FIG. 3 shows a high level schematic view of a system for searching for an advertisement, according to a third embodiment of the invention; and

FIG. 4 shows a flow chart representing a method of searching an advertisement, which may be implemented using the system in FIG. 3, according to a fourth embodiment of the present invention.

### DESCRIPTION OF EMBODIMENTS

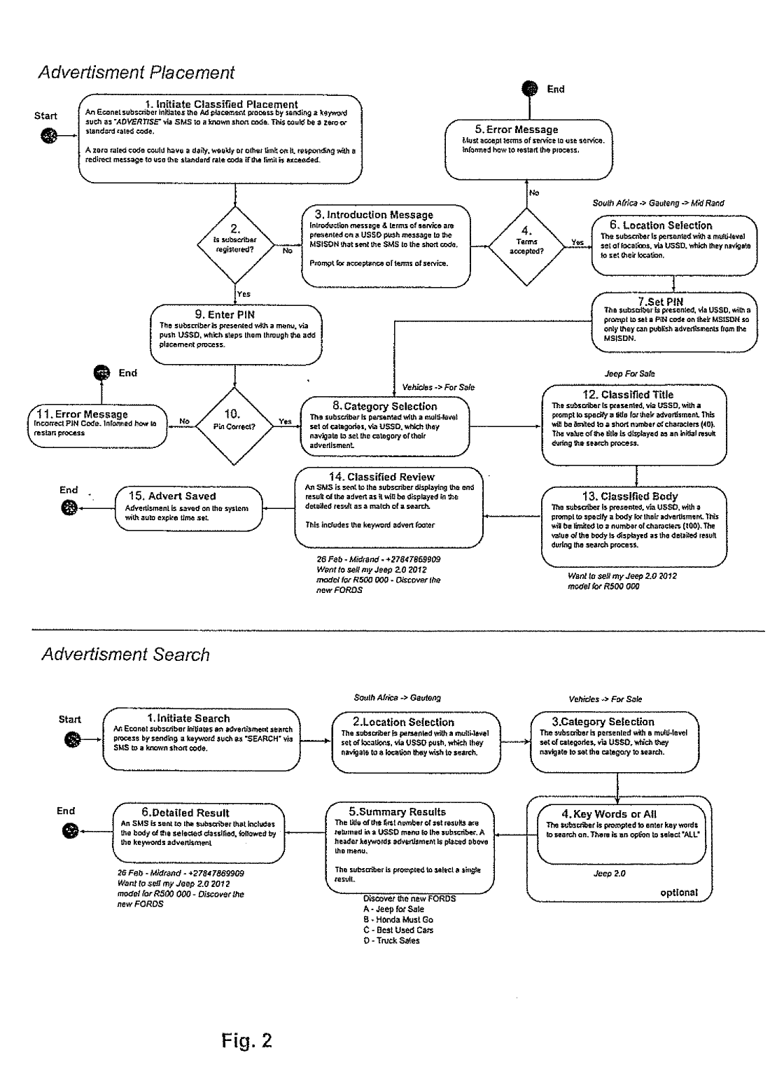

Referring first to FIG. 2, a method of compiling an advertisement, preferably using a mobile device and related mobile technology, is shown. It will be appreciated that the advertisement could be for a product and/or service and/or information.

The method comprises receiving an electronic request to place an advertisement from a mobile device associated with an advertiser, as described in block 1.

The mobile device could be a mobile telephone or tablet device or any other suitable mobile technology.

After a number of intermediate steps, which will be described in more detail further below, the method allows the advertiser to select a product or service category in respect of which he or she wishes to advertise, as described in block 8. As indicated in this block, this step may be achieved by presenting the advertiser with a multi-level set of categories for selection by the advertiser.

The advertiser will input information typically using a user interface of their mobile telephone which may include but is not limited to a keyboard of the mobile telephone and/or voice recognition software.

Thereafter, the advertiser is prompted to compile information regarding the product or service to be advertised. In an embodiment, this step comprises the steps of prompting the advertiser to provide a title for the advertisement (as described in block 12) and then prompting the advertiser to provide the body of the advertisement (as described in block 13).

After receiving information regarding the product or service to be advertised, the method comprises collating the information to define a primary advertisement. The primary advertisement comprises one or more of the following: the date, the advertiser's location, the advertiser's mobile device's telephone number, the product or service being advertised and the related cost, as shown in block 14.

In addition, the method comprises extracting from a database a secondary advertisement, and appending the secondary advertisement to the primary advertisement, so as to define a combined advertisement. Block 14 also describes and shows the result of these steps, and also mentions that the secondary advertisement may be appended to the footer (i.e. the end) of the primary advertisement.

In an embodiment, the secondary advertisement is related or connected to the product or service category and/or the product or service being advertised. Thus, in this case, a Jeep vehicle is being advertised, and thus the secondary advertisement, namely “Discover the new FORDS” is also vehicle-related.

In an embodiment, after appending the secondary advertisement to the primary advertisement, the method comprises sending the combined advertisement to the advertiser for approval, as is also described in block 14. Upon receiving approval, the method comprises storing the combined advertisement in the database for subsequent retrieval, as described in block 15.

Although not shown, the method comprises allowing the advertiser to request further information regarding the secondary advertisement, which in turn comprises sending a message with further details and/or contact details that the advertiser may use and/or a URL link to a web site with further details.

The secondary Ad may be in at the top, middle or end of the primary Ad or in any suitable place when displayed to the user.

When the advert is displayed it can be automatically summarized by the system.

Turning back to a number of the intermediate steps, the method comprises determining whether the advertiser is registered with a host running the method, as indicated in block 2. It will be appreciated that this could be implemented without requiring the user to be registered.

If the advertiser is registered, a PIN is requested (block 9), and if correct the method proceeds to block 8 described above. If the PIN is incorrect, an error message is returned (block 11).

If, however, the advertiser is not registered, the method comprises registering the advertiser, which in turn comprises any one or more of the following steps:
presenting an introductory message and related terms and conditions (block 3), and prompting the advertiser to accept the terms and conditions (block 4);
determining the advertiser's location (block 6), which in turn may include presenting the advertiser with a multi-level set of locations for selection by the advertiser; and
prompting the advertiser to set a PIN (block 7), for subsequent use to ensure that an operator of the mobile device is authorized to place advertisements.

In addition, at the time of registering the user's payment information can be captured, for example the user's credit card details, which can then be used automatically in future to place adverts.

In an embodiment, the mobile technology comprises any one or a combination of USSD (Unstructured Supplementary Service Data), SMS (Short Message Service) and MMS (Multimedia Message Service). The present invention may thus use a hybrid of SMS and USSD to make the process easier, and will be used in areas that have USSD push enabled on the cellular network.

In one example, the system uses USSD technology right from introduction and only uses an SMS to confirm placing of the Ad. In another example, the system uses SMS technology right from the start and USSD to confirm Ad or any other suitable technology.

In another example, the methodology could be implemented using a smartphone to access the internet and/or having an application running thereon which allows the user to place the advert by uploading similar information as described below.

It will be appreciated that alternatively or in addition, the advert could be placed using a computer other than a mobile device to access the internet.

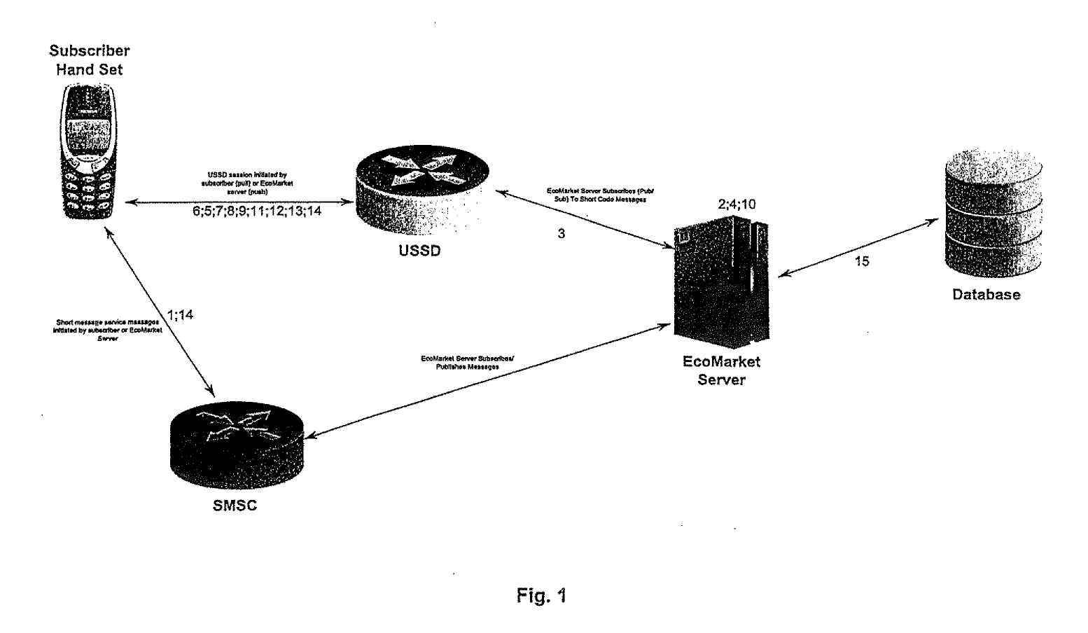

In any event, in one example embodiment, and with reference now to FIG. 1, an SMS will initiate the process by having a user (i.e. the advertiser) send a predetermined word, such as “Sell”, to a SMS short code. Once the SMS is sent, the system will record the MSISDN (Mobile Station Integrated Services Digital Network) which is used to identify the user and is in the form of a mobile number. Once the SMS is received, it is sent to a USSD gateway which then opens a USSD push session between the USSD gateway and the MSISDN. In this way, many steps of the process can be stringed together as a session that would share a session ID which would remain intact, until the session is terminated by the user or the USSD gateway.

The first time the user sends an SMS (or initiates the process using USSD), the system will check to see if the user MSISDN is registered on the system. If it is, the user will be required to enter a 4 digit PIN (Personal Identification Number) to verify that the person is a registered/authorised user of the system.

Alternatively or in addition, biometrics may be used to identify the user such as using a fingerprint reader associated with the mobile phone.

If the MSISDN is not recognised, an USSD session will be initiated, asking the user to register with the system.

Before registration, the user is required to digitally sign terms and conditions for using the system. The process to do this is to reply with the word “YES”, which will be added to the database in a Boolean field. If the answer is YES and the terms and conditions are accepted, the registration process begins.

Registration consists of providing a few answers to a series of prescribed questions, which may include location, gender, family name, first name, language and age and may include other information relating to family or friends or the person's work. These answers will be stored in the database.

Once the information is stored, the user will have the option of placing an advert to sell, rent or trade an item or service. The user will also have the option to search the existing database of adverts, but this will be described further below. This is done by sending a word, such as “Sell” or “Search”, which will allow the user to place an advert, or search the database.

The subscriber has a MSISDN (Mobile Station Integrated Services Digital Network) which identifies him/her. A 4 digit PIN (Personal Identification Number) will be added to the system upon registration for security purposes, and this will prevent others using the MSISDN to place adverts.

The user will be asked to provide their location, and this will be selected from a list that will be provided using a USSD session. Alternatively, the location can be determined by determining the location of the mobile telephone of the users.

The purpose of this location information is to enable the system to store the user's location and to use the location to provide the user with search results that are nearest to their location, to facilitate collection/delivery of the item being advertised.

To place an advert, the user needs to send an SMS or USSD to a short code, the word to place an advert, such as “Place”, “Advertise” or “Sell” (or a USSD menu option in the case of a USSD session). This is a predefined word and will initiate a USSD push session; if USSD push is not active in the user's area, the process may continue using SMS.

Once the session is open, the user will be presented with a list of pre-defined categories, with each category being assigned a number, with the user then entering the corresponding number to the category he wishes to advertise in. There may be a second selection of sub-categories, which the user may now need to perform the same procedure as for the main category. The user will then be prompted to create a title for the item they wish to sell/trade/auction, and this is limited to a short number of characters. Once the user has entered a title, for example, “NEW PHONE FOR SALE” the user will be prompted to add a brief description of the item or service, and this will also be limited to a certain number of characters. The description may be, for example NOKIA LUMINA—IN BOX—UNWANTED GIFT—$20.

Once the advert is complete, and after appending the secondary advertisement as described above, the user will get a prompt to let him know that the advert has been successfully stored in the database. The user will have an option to view the advert once complete. The user also will have the ability to delete the advert if the item is sold.

The adverts have a limited life on the system and once the pre-defined time is reached the advert will be disabled from the database, the user will have the option to re-instate it or change the wording if they want to continue advertising it thereafter. The advertiser is also provided with the option of only displaying the advert for a limited amount of time.

Turning now to FIG. 1 in particular, a system for implementing the method shown in FIG. 2 is shown. Most of the components in FIG. 1 have already been described, but at a high level, the system comprises a database to store a plurality of secondary advertisements. The system further comprises a processor, in the form of a server (labelled “EcoMarket Server” in FIG. 1) to access the database and to implement the steps in the method described above with reference to FIG. 2.

The database contains the required tables and rules, and can be accessed from either a SMSC (Short Message Service Centre) or a USSD (Unstructured Supplementary Service Data) gateway. As is well know, USSD is a session based protocol, and is used to query information and trigger services, where SMS and MMS are store and forward based.

For the sake of clarity, between the mobile device (i.e. the Subscriber Hand Set in FIG. 1) and the USSD gateway, an arrow is shown above a series of numbers, namely 5, 6, 7, 8, 9, 11, 12, 13 and 14. These numbers correspond to the blocks in FIG. 2, and thus represent the nature of the communications between the mobile device and the USSD gateway. Similarly, the numbers next to the arrow extending between the mobile device and the SMSC, namely 1 and 14, correspond to block 1 and 14 in FIG. 2. Also similarly, the number 3 next to the arrow between the USSD gateway and the server corresponds to block 3 in FIG. 2, and the number 15 next to the arrow between the server and the database corresponds to block 15 in FIG. 2.

A further example embodiment of the method described above is as follows.

A message may be transmitted to the user via USSD or SMS such as Dial: *120*321# to register for Loveworld Classified Ads service. Access is free and you qualify for 1 free Classified Ad (up to 160 characters) per week

If the user dials the string they will received the following:

Welcome to LOVEWORLD Classifieds Ads

Please choose:

1—To view terms and conditions

2—To register

Upon choosing 2 the user will receive

Please enter your own personal 4 digit PIN number to register for Loveworld Classifieds

The mobile phone user enters PIN: 1980 (for example) and receives:

Please confirm your 4 digit PIN

Mobile phone user confirms 4 digit PIN: 1980 and receives:

Congratulations! Your registration for Loveworld Classified Ads was successful. Every Friday you qualify for 1 free Classified Ad (up to 160 characters)

Please choose:

1—Next

If the mobile phone user chooses option: 1 they receive:

Please note you only qualify for 1 free Classified Ad (up to 160 characters) per week. Any additional ad or more than 160 characters will be charged at normal SMS rates

Choose:

1—Next

If the mobile phone user chooses option: 1 they receive:

Welcome to Loveworld Classifieds Ads

Please choose:

1—Place an Classified Ad

2—Search Classified Ads

3—Advertise with Signature Ads

4—View personal Ads history

5—Next

If the user is already registered they may place an Ad after registration by dialing a USSD code to activate session, for example *120*321# and the will receive:

Welcome to Loveworld Classifieds Ads.

Please enter your 4 digit PIN

The mobile user enters their PIN: 1980 and receives the same message as above:

Welcome to Loveworld Classifieds Ads

Please choose:

1—Place a Classified Ad

2—Search Classified Ads

3—Advertise with Signature Ads

4—View personal Ads history

5—Next

If the mobile phone user chooses option: 1 they receive:

Choose region to advertise your Classified Ad:

1—Gauteng

2—Limpopo

3—Mpumalanga

4—Kwazulu Natal

5—Eastern Cape

6—Western Cape

7—Northern Cape

8—North West Province

9—Back

If the mobile phone user chooses option 1 for example, they receive:

Choose suburb to advertise your Classified Ad

1—Fourways

2—Randburg

3—Sandton

4—Bryanston

5—Johannesburg Central

6—Rivonia

7—Germiston

8—Kempton Park

9—Next

10—Back

In our example the mobile phone user chooses option 8 and receives:

Please choose category to advertise:

1—Health—Beauty

2—Jobs

3—Mobile Phones & Tablets

4—Electronics

5—Vehicles

6—Properties

7—Other

8—Back

In our example the mobile phone user chooses option 5 and receives:

Please choose:

1—Sell new car

2—Sell used car

3—Want to buy a new car

4—Want to buy a used car

5—Other

6—Back

In our example the mobile phone user chooses option 2 and receives:

Please choose car make to advertise:

1—Volkswagen

2—Toyota

3—BMW

4—Mercedes-Benz

5—Kia

6—Hyundai

7—Chevrolet

8—Ford

9—Nissan

10—Refine search

11—Back

12—Next

In our example the mobile phone user chooses option 1 and receives:

Please choose car color:

1—Black

2—Red

3—Silver

4—White

5—Silver

6—Gold

7—Other

8—Other

9—Back

In our example the mobile phone user chooses option 2 and receives:

Please choose

1—Total kilometers of car

2—Don't know kilometers of car

3—Back

The user chooses option 1 and receives:

Please enter total kilometers of your car

The user enters 4100 for example and receives:

Is your car

Please choose:

1—Petrol

2—Diesel

The user chooses option 1 and receives:

Is your car

Please choose:

1—Manual

2—Automatic

The user chooses option 1 and receives:

The amount you want

The user enters 110 000 for example.

Alternatively or in addition, the system may automatically enter mobile phone user's details for the Ad if these have been pre-stored. So for example: mobile number, region, selling or buying, car make, colour, kilometres, manual or automatic, how much money for car etc. The system will then indicate to the user how many characters are left of 160.

In this example, the mobile phone user receives:

Please enter your Classified Ad up to 160 characters:

0833097381 Kempton Park Sell new Volkswagen Red 4100 Km Petrol Manual 8110 000 (83 characters left)

The user will now enter: Polo 1.6 Comfort line 5dr Hatchback and receive:

Your Ad:

0833097381 Kempton Park Sell new Volkswagen Red 4100 Km Petrol Manual Polo 1.6 Comfort line 5dr Hatchback Price R110 000

1—Place Ad

2—Back

The user chooses option 1 and receives:

An SMS has been send to 0833097381 to confirm your Ad (Ref nr 10123)

1—Back

In this example, the user receives an SMS:

Please SMS just your Ref 10123 to: 123 to confirm your Classified Ad

In this example, the reference 10123 is the advertisers code by which they can quickly locate their advert in the system.

In addition to the above, the system may automatically suggest an improvement to the Ad or on request rewrite the Ad automatically. Also the software can automatically put more popular categories (jobs, home etc.) first when searching/advertising or remove categories not popular.

Furthermore, the system may check the advert for appropriate content, such as filtering out swear words or assessing the advert and placing an age category rating on the advert so that it does not get forwarded to children if inappropriate, for example.

The system may also assist with the price by automatically display a suggested price or price indication from average prices in other Ads.

In terms of the secondary advert, it can be obtained by the system from one or more of a number of places.

For example, a mobile network can decide to place their own brand there if for example they have no advertiser for the secondary advertisement in a category or service.

An individual or company can place a secondary ad directly with the system. They will typically access the system using USSD or any suitable technology and place the secondary advert and make payment using mobile banking for example.

The system will also display what categories or sections are still available to place secondary adverts.

Alternatively or in addition, advertisers will be given different options when placing the secondary advertisement. For example choosing a specific category to advertise.

The secondary advert can also be next to a category or area or any suitable place.

It will be appreciated that the secondary advert can be added to the primary advert by the system at the server and then sent to the USSD/SMS switch or any suitable technology as a combined message. In this example, the words of the USSD/SMS will be counted, the words of the signature will also be known and the system will make sure that the USSD/SMS length is not exceeded, even if it truncates the message and sends it through as a second message.

The secondary advert can also be received via a software upload or pre-loaded onto customer's communication device and extracted from there.

Furthermore, the secondary adverts can also be categorised in specific targeted segments, and can be sent in a rotational basis, so if the viewer requests three adverts and the system has three secondary adverts in that category, then they will not see the same one twice, if the specific target section has no adverts, or only has one, a global signature file will be used and may advertise the service provider or network providing the service.

Turning now to FIG. 4, a second aspect of the invention, namely a method of searching for an advertised product or service, using a mobile device and related mobile technology, will now be described. The method comprises receiving an electronic request to search an advertisement from a mobile device associated with a subscriber, as shown in block 1. The method then comprises determining the subscriber's location, by presenting the subscriber with a multi-level set of locations for selection by the subscriber, as shown in block 2. The subscriber can then select a product or service category in respect of which he or she wishes to search, as shown in block 3. The method then comprises prompting the subscriber to submit information regarding the product or service to be searched, and then receiving information regarding the product or service to be searched, as shown in block 4.

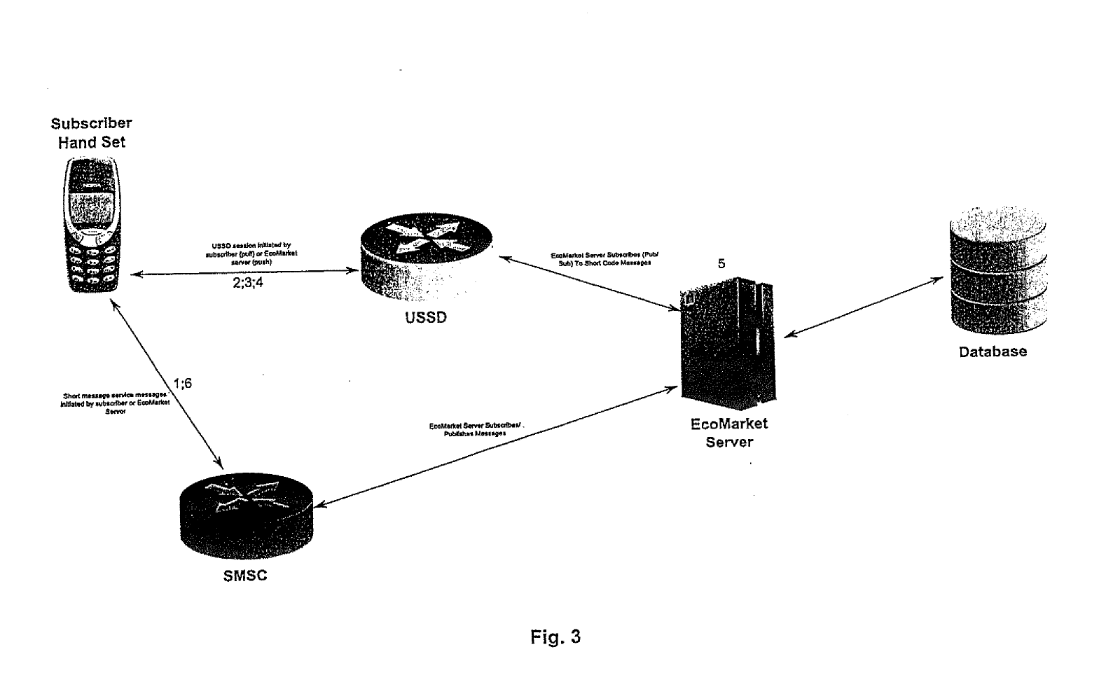

After searching a database (of the type shown in FIG. 3) for matching products or services, the method comprises collating the information to define a primary advertisement, comprising at least one matching product or service. A secondary advertisement is then extracted from the database, and then appended to the primary advertisement, so as to define a summarised advertisement. This is described in block 5 of FIG. 4, which also shows that in one version the secondary advertisement (i.e. “Discover the new FORDS”) is appended to the header (i.e. the top), footer (i.e. bottom) or middle of the primary advertisement.

Block 5 also mentions that the summarised advertisement is then sent to the subscriber, with the subscriber then being prompted to select one of the at least one matching product or service in respect of which he or she is particularly interested in. After this has been done, the method further comprises extracting from the database further information regarding the selected product or service, including the date of advertisement, the advertiser's location, the advertiser's mobile device's telephone number, the product or service being advertised and the related cost. In one version, as shown in block 6, this step comprises collating the information extracted from the database to define a detailed advertisement, appending the secondary advertisement to the detailed advertisement, so as to define a detailed combined advertisement, and sending the detailed combined advertisement to the subscriber. In this regard, the step of appending the secondary advertisement to the detailed advertisement includes the step of appending the secondary advertisement to the footer (i.e. the end) of the primary advertisement, as shown in block 6.

As previously described, the secondary advertisement is ideally related or connected to the product or service category and/or the product or service being searched. However, in one version, the step of prompting the subscriber to submit information regarding the product or service to be searched includes the step of allowing the subscriber to search for all advertised products or services. If the subscriber wishes to search for all advertised products or services, the secondary advertisement is randomly chosen from the database.

In an embodiment, in view of the limited length and thus the limited amount of information that can be provided in respect of the secondary advertisement, the method comprises allowing the subscriber to request further information regarding the secondary advertisement. This in turn may comprise sending a message with further details and/or contact details that the subscriber may use and/or a URL link to a web site with further details.

Thus, in use, and with reference now to FIG. 3, if a user wishes to search advertisements stored in the database, a predetermined action word, such as “SEARCH” may be sent to a designated short code either by SMS or by initiating a USSD session and responding accordingly. Once this has been done, a USSD session will open and the subscriber may be prompted to register if he/she is not yet registered (as described above). If the subscriber is registered, the subscriber will be presented with a list of categories, with each category being linked to a number. Once they select the corresponding number, the subscriber may be presented with a subcategory. Once the subscriber has selected a subcategory, the search functionality will present the subscriber with a list of matches to the search, comprising headings of the matching advertisements, with each heading having a linked identifier (in this case, letters A to D corresponding to “Jeep for Sale”, “Honda Must Go”, “Best User Cars” and “Truck Sales”, respectively.

Conveniently, the system may automatically filter the search results and display the results that are closest to the subscriber's location. This will facilitate the delivery/collection of goods.

After selecting the relevant identifier, a full advert (typically in the form of an SMS) will be sent to the subscriber, the full advert comprising a title, a body, the date on which the advertisement was uploaded onto the database and the MSISDN of the seller. The SMS will also contain a secondary advertisement, which is an advertisement that is added to the end of the SMS, as described above. This advert will be selected by a process of relevance filtering and will also be placed in a rotational system. This means that if a subscriber is searching for used cars, for example, the subscriber would see different secondary advertisements each time, even if the subscriber is searching within the same category. In addition, the secondary advert can be selected based on the location of the advertiser or view depending either on their selection when inputting or searching for vehicles or alternatively by using the location of their mobile telephone. Where the viewer changes location, the secondary advert dynamically updates.

As described above, in view of the limited length and thus the limited amount of information that can be provided in respect of the secondary advertisement, the method comprises allowing the subscriber to request further information regarding the secondary advertisement. This in turn may comprise sending a message with further details and/or contact details that the subscriber may use and/or a URL link to a web site with further details.

In addition, before placing the advert the system may use the mobile number or any form of identification determined by network or advertiser to ensure the Ad is not duplicated on Internet/website or future technology etc.

Another example of doing a search on Mobile Classified Ads using USSD will now be described.

Mobile user dials the USSD code to activate session: *120*321# and receives:

Welcome to Loveworld Classifieds Ads.

Please enter your 4 digit PIN

Mobile phone user enters PIN: 1980 and receives:

Welcome to Loveworld Classifieds Ads

Please choose:

1—Place an Classified Ad

2—Search Classified Ads

3—Advertise with Signature Ads

4—View personal Ads history

5—Next

The user will now select option 2 and will receive:

Search

Please choose:

1—National

2—Gauteng

3—Limpopo

4—Mpumalanga

5—Kwazulu Natal

6—Eastern Cape

7—Western Cape

8—Northern Cape

9—North West Province

10—Back

If the user chooses option 2 for example, they will receive:

Search

Please choose:

1—Health—Beauty

2—Jobs

3—Mobile Phones & Tablets

4—Electronics

5—Vehicles

6—Properties

7—Other

8—Back

If they now choose option 5 they will receive:

Mobile user receives:

Search

Please choose:

1—Buy new car

2—Buy used car

3—Sell new car

4—Sell used car

5—Other

6—Back

The user chooses option 2 and receives:

Search

Please choose:

1—Volkswagen

2—Toyota

3—BMW

4—Mercedes-Benz

5—Kia

6—Hyundai

7—Chevrolet

8—Ford

9—Nissan

10—Refine search

11—Back

12—Next

If the user chooses option 1 the will receive:

Please choose:

1—Burgundy VW Polo 1.4 89000 km 2001

2—VW Polo 1.2 2013 Diesel Hatchback

3—VW Polo Vivo 1.4 Trend 2013

4—VW Microbus 1999 Bus

5—VW Polo 1.6 Comfort line 5dr 2014

6—Back

7—Next

8—Finance your vehicle

In our example the user chooses option 5 and receives mobile user receives USSD:

2014 Volkswagen Polo 1.6 Comfort line 5dr Petrol Manual Silver Randburg Hatchback 742 km Phone John 0149400148—FINANCE @ WESBANK

1—Back

The secondary advert in this example is the Finance at Wesbank advert.

In addition to the above, once the user has selected an advert, the combined advert is also e-mailed to a pre-captured user e-mail address. This is because the USSD session expires and the user will lose the information so this way the user will be able to access the advert and secondary advert at a later time.

If no product is available, the system stores the request and if the product does come available at a future point in time will transmit the appropriate advert together with a secondary advert to the user then via any suitable communication means.

It will be appreciated that other search technologies could be used by the searcher, for example the search can be either done via USSD where the customer can send/dial/speak a word or category number to the server as described above, which in turn will respond either via USSD or SMS, depending on network capabilities or a hybrid system may be used to carry out this task. For example, a USSD could be sent, and the reply may be via a USSD menu system to navigate the categories.

Users could also browse from a website, send adverts in via e-mail or even via an app that enables the user to submit data to our search function, that will in turn interrogate the database.

In one example the advert is played back to the user in a user selected language so that the user does not need to read the advert but will hear the advert.

If the user placed advert is shorter than the allowed length, the system will automatically increase the size of the secondary advert.

The USSD string may include a link by means of which the user can be directed to a website for the product and/or service.

It will be appreciated that the advert could be delivered to the user by USSD, SMS, MMS, Internet or voice or any form of communication with no human intervention.

If a number of adverts are displayed, typically the advert that was posted most recently will be displayed first.

Turning now to FIG. 3 in particular, a system for implementing the method shown in FIG. 4 is shown. Most of the components in FIG. 3 have already been described, but at a high level, the system comprises a database to store a plurality of advertised products and services and a plurality of secondary advertisements. The system further comprises a processor, in the form of a server (labelled “EcoMarket Server” in FIG. 3) to access the database and to implement the steps in the method described above with reference to FIG. 4. Again, as described above, the database contains the required tables and rules, and can be accessed from either a SMSC (Short Message Service Centre) or a USSD (Unstructured Supplementary Service Data) gateway.

For the sake of clarity, between the mobile device (i.e. the Subscriber Hand Set in FIG. 1) and the USSD gateway, an arrow is shown above a series of numbers, namely 2, 3 and 4. These numbers correspond to the blocks in FIG. 4, and thus represent the nature of the communications between the mobile device and the USSD gateway. Similarly, the numbers next to the arrow extending between the mobile device and the SMSC, namely 1 and 6, correspond to blocks 1 and 6 in FIG. 2.

Clearly, although reference is made exclusively to mobile devices, it should be understood that an internet based website or a smart phone application may be used to implement the methods described above with reference to FIGS. 2 and 4.

In terms of allowing the user to view a picture or video for the advertised product or service, this could be sent to the user's phone directly or an internet link could be sent to the phone.

Alternatively or in addition, the user can also request for a picture or video of the primary or secondary Ad to be send via any form of suitable communication at a cost or no cost.

In this regard, augmented reality may be used whereby a live or indirect view of physical, real-world environment whose elements are augmented (or supplemented) by computer-generated sensory input such as sound, video, graphics or GPS data is used.

In addition the above, a language converter is included so the user is given the option of selecting a language by USSD and the advert will then be delivered to them in the language of their choice.

Alternatively or in addition, the user may look at their mobile phone using a pica projector attached or embedded in mobile phone to view the advert, for example.

It will be appreciated that both the primary advertised and secondary advertiser can be charged for placing the adverts.

The system may also include an option to allow the user to buy the advertised product and/or service by selecting a purchase option and messaging this back to the system.

In one example, the system is set up to automatically recommend to a user a product or service. For example, if a job gets advertised which the user is looking for, they will receive an alert from the system.

In this scenario, payment for the product and/or service will need to be obtained from the user. This could be obtained in any one of a number of ways including directing the user a mobile banking application, or to input credit card details or in an Internet-based environment directing the user to a payment website such as Paypal. If possible, the user's mobile telephone account can be billed directly.

In terms of searching, where the user searches using key words, the system may suggest further key words based on user's past likes or dislikes or search history.

When a product rented or owned by a customer needs repair or replacement, the product will communicate with communication device which can automatically search products or services advertised and make a suggestion to a customer on best price, quality, brand etc.

It will be appreciated that the system could be implemented for a specific country or could be implemented using one system that services many countries.

1. A method of compiling one or more advertisement, the method comprising:
receiving via one or more communications network one or more request from one or more advertiser to place one or more advertisement;
allowing one or more advertiser to select one or more product and/or service category in respect of which he or she wishes to advertise;
prompting one or more advertiser via one or more communications network to compile information regarding one or more product and/or service to be advertised;
receiving via one or more communications network information regarding one or more product and/or service to be advertised;
collating the information to define a primary advertisement, comprising one or more of the following: the date, the advertiser's location, the advertiser's contact details and the product and/or service being advertised;
extracting from one or more database a secondary advertisement;
appending the secondary advertisement to the primary advertisement, so as to define a combined advertisement; and
transmitting one or more combined advertisement to one or more device.

2. A method according to claim 1 wherein the step of allowing the one or more advertiser to select one or more product and/or service category in respect of which he or she wishes to advertise comprises presenting the one or more advertiser with a multi-level set of categories for selection by the one or more advertiser.

3. A method according to claim 1 wherein the step of prompting the one or more advertiser to compile information regarding the one or more product and/or service to be advertised comprises the steps of prompting the one or more advertiser to provide the one or more body and/or title of the one or more advertisement.

4. A method according to claim 1 wherein the secondary advertisement is related or connected to the product and/or service category, and/or the product and/or service being advertised.

5. A method according to claim 1 wherein the step of appending the secondary advertisement to the primary advertisement includes the step of appending the secondary advertisement to the header, footer or middle or any suitable place of the primary advertisement.

6. A method according to claim 1 wherein the method comprises sending one or more primary advertisement to one or more advertiser for approval, and upon receiving approval, the method comprises storing the one or more advertisement in one or more database for subsequent retrieval.

7. A method according to claim 1 wherein after appending the secondary advertisement to the one or more primary advertisement, the method comprises sending the one or more combined advertisement to the one or more advertiser for approval, and upon receiving approval, the method comprises storing the one or more combined advertisement in the one or more database for subsequent retrieval.

8. A method according to claim 1 wherein the method comprises allowing the one or more advertiser to request further information regarding the secondary advertisement, and sending one or more message with further details and/or contact details that the one or more advertiser may use and/or one or more URL link to one or more web site with further details.

9. A method according to claim 1 wherein the method comprises the step of determining whether the one or more advertiser is registered with a host running the method, and if the one or more advertiser is not registered, the method comprises registering the one or more advertiser, which in turn comprises any one or more of the following steps:
presenting one or more introductory message and/or related terms and conditions, and prompting the one or more advertiser to accept the terms and conditions;
determining the advertiser's location;
prompting the one or more advertiser to set one or more PIN, for subsequent use to ensure that one or more operator of one or more device is authorized to place advertisements, and
capturing the one or more advertiser's payment information which can then be used automatically in future to place adverts.

10. A method according to claim 9 wherein the one or more PIN is a biometric of the one or more advertiser.

11. A method according to claim 1 wherein the method includes automatically suggesting one or more improvement to the one or more advert

12. A method according to claim 1 wherein if the one or more primary advertisement is shorter than an allowed length, automatically increasing the size of the secondary advertisement.

13. A method according to claim 1 further including allocating one or more reference code to the one or more advert by which the one or more advertiser can quickly locate their one or more advert in the system.

14. A method according to claim 1 wherein the method is implemented using mobile technology which comprises any one or a combination of USSD (Unstructured Supplementary Service Data), SMS (Short Message Service) and MMS (Multimedia Message Service).

15. A method of searching for one or more advertised product and/or service, the method comprising:
receiving via one or more communications network one or more request from one or more device associated with one or more user to search for one or more advertisement;
allowing one or more user to select at least one or more product and/or service category in respect of which he or she wishes to search;
prompting one or more user via one or more communications network to submit information regarding the one or more product and/or service to be searched;
receiving information via the one or more communications network regarding the one or more product and/or service to be searched;
searching one or more databases for matching products and/or services;
collating the information to define one or more primary advertisement, comprising of one or more matching product and/or service;
extracting from one or more databases a secondary advertisement;
appending the secondary advertisement to one or more primary advertisement, so as to define one or more combined advertisement; and
transmitting one or more primary and secondary advertisement to one or more device.

16. A method according to claim 15 wherein the step of appending the secondary advertisement to one or more primary advertisement includes the step of appending the secondary advertisement to the header, footer or middle or any suitable place of the one or more primary advertisement.

17. A method according to claim 15 comprising sending the one or more combined advertisement to the one or more user, and prompting the one or more user to select one or more matching product and/or service in respect of which he or she is particularly interested in.

18. A method according to claim 15 wherein for the selected one of the one or more matching product and/or service, the method further comprises extracting from the database further information regarding the selected product and/or service, including one or more of the following: the date of advertisement, the advertiser's location, the advertiser's contact details and/or the product and/or service being advertised.

19. A method according to claim 15 wherein the method further comprises:
collating the information extracted from the one or more database to define one or more primary advertisement;
appending the secondary advertisement to the one or more primary advertisement, so as to define one or more combined advertisement; and
sending the one or more combined advertisement to the one or more user.

20-33. (canceled)

34. A system for compiling one or more advertisement, the system comprising:
one or more database to store a plurality of secondary advertisements; and
one or more processor to access one or more database, and which is arranged to:
receive via one or more communications network one or more request from one or more device associated with one or more advertiser to place one or more advertisement;
allow the one or more advertiser to select via the one or more communications network one or more product and/or service category in respect of which he or she wishes to advertise;
prompt the one or more advertiser via the one or more communications network to compile information regarding the one or more product and/or service to be advertised;
receive via the one or more communications network information regarding the one or more product and/or service to be advertised;
collate the information to define a primary advertisement, comprising of one or more of the following: the date, the advertiser's location, an advertiser's contact details and/or the product and/or service being advertised;
extract from the one or more database a secondary advertisement; and
append the secondary advertisement to the one or more primary advertisement, so as to define one or more combined advertisement.

35. (canceled)
